(19) United States
(12) Patent Application Publication
(10) Pub. No.: US 2018/0303057 A1
(43) Pub. Date: Oct. 25, 2018

(54) INTEGRATED FULLY-ENCLOSED CAT TOILET

(71) Applicant: BEIJING MAKAR PETS PRODUCTS CO., LTD., Beijing (CN)

(72) Inventor: Zhang Guoqiang, Beijing (CN)

(21) Appl. No.: 15/768,119

(22) PCT Filed: Oct. 20, 2016
(86) PCT No.: PCT/CN2016/102680

§ 371 Date: Apr. 13, 2018

(30) Foreign Application Priority Data
Oct. 15, 2015 (CN) 201520798267.X

(51) Int. Cl. A01K 1/01

(52) U.S. Cl. CPC A01K 1/0107

(57) ABSTRACT

The present utility model provides an integrated fully enclosed cat lavatory comprising a cat lavatory body and a cat litter pan, wherein: the cat lavatory body is hexahedral, the cat lavatory body has an open underside, the shape of the cat litter pan and that of the open underside of the cat lavatory body are adaptable to each other, the top and two sides of the cat lavatory body are curved, the front of the cat lavatory body is provided with a circular opening for a cat to get in and out, a cat litter footboard extending into the cat lavatory body is provided at the bottom of the circular opening, engagement slots are disposed beneath the circular opening for the cat litter pan to be engaged therewith, the cat litter pan is slid to be placed into the cat lavatory body to enclose the open underside of the cat lavatory body. The present utility model is structurally simple, integrally formed and easy to clean.

### FIELD

The present utility model relates to a pet care article and, more particularly, to an integrated fully enclosed cat lavatory for use by pet cats.

### BACKGROUND

Prior art pet cat lavatories are typically designed to be open, and as the design allows convenient use by pet cats and is structurally simple and easy to clean, they are widely sold on markets. However, this type of open design has some disadvantages. Pet cats have a living habit of preferring a quiet and concealed environment when eating and defecating. When a pet cat is using an open-type cat lavatory, the pet can be seen from the outside and is often more easily disturbed, and this results in the cat defecating surrounding the cat lavatory and causes hygiene maintenance problems. In addition, due to the design of the open-type cat lavatory, odor diffusion will occur if the cat lavatory is not promptly cleaned after use by a pet cat.

To resolve the aforesaid problems, there exists the addition of a lid structure to prior art cat litter pan, but the structure does not facilitate easy cleaning of the cat lavatory because the lid must be separated from the cat litter pan for cleaning up the cat's excrement, and this makes the operation process complex, increases the amount of labor and also makes the lid and the cat litter pan prone to be separated during transportation.

Due to the aforementioned problems, the provision of an enclosed cat lavatory capable of providing an enclosed environment and that is easier to clean is a problem needing to resolved by the industry.

### SUMMARY OF THE INVENTION

The present utility model aims to provide an integrated fully enclosed cat lavatory comprising a cat lavatory body and a cat litter pan, wherein: the cat lavatory body is hexahedral, the cat lavatory body has an open underside, the shape of the cat litter pan and that of the open underside of the cat lavatory body are adaptable to each other, the top and two sides of the cat lavatory body are curved, the front of the cat lavatory body is provided with a circular opening for a cat to get in and out, a cat litter footboard extending into the cat lavatory body is provided at the bottom of the circular opening, engagement slots are disposed beneath the circular opening for the cat litter pan to be engaged therewith, the cat litter pan is slid to be placed into the cat lavatory body to enclose the open underside of the cat lavatory body.

In one embodiment of the present utility model, a revolving door is disposed at the circular opening for enclosing the circular opening.

In one embodiment of the present utility model, the revolving door is pivotally fixed to the circular opening.

In one embodiment of the present utility model, the cat lavatory body is provided with two snap-fit connectors disposed on two sides thereof and the snap-fit connectors are engaged with two sides of the cat litter pan to fix the cat litter pan to the cat lavatory body.

In one embodiment of the present utility model, the cat lavatory body is provided with a handle disposed on the top thereof, and the handle is disposed in a retractable manner.

In one embodiment of the present utility model, the cat lavatory body is provided with a retraction space disposed on the top thereof, and the retraction space is concaved from the top of the cat lavatory body formed integrally with the cat lavatory body.

In one embodiment of the present utility model, the

retraction space is provided with a lid, and the shape of the lid and that of the retraction space are adaptable to each other.

In one embodiment of the present utility model, the retraction space and the lid are provided with ventilation holes disposed thereon.

In one embodiment of the present utility model, the cat lavatory body is provided with slide ways disposed on two sides thereof near the bottom thereof to guide the cat litter pan into the cat lavatory body when the cat litter pan is being placed into the cat lavatory body.

In one embodiment of the present utility model, the cat litter pan is like a drawer, the bottom of the cat litter pan is provided with wavy structures, and each of the wavy structures is provided with rib reinforcement longitudinally disposed along the wavy structure at the bottom thereof.

The present utility model is structurally simple, integrally formed and easy to clean. As the cat litter pan is designed like a drawer, the cat lavatory of the present utility model is made easier to clean, and the wavy design at the bottom of the cat litter pan not only enhances the bearing capacity of the bottom thereof but also reduces the problem of product deformation and improve product durability. Each of the wavy protruding portions at the bottom of the cat litter pan is provided with rib reinforcement to reduce friction between the cat litter pan and the floor when the former is slid like a drawer. The design of the revolving door allows a pet cat to get in and out of the cat lavatory more conveniently and it makes enclosing the cat lavatory easier, thereby providing a safe and concealed environment for the pet. The integral design of the cat lavatory is capable of effectively preventing odor diffusion, providing a more enclosed environment and preventing cat litter from spilling out of the cat litter pan.

### BRIEF DESCRIPTION OF THE DRAWINGS

FIG. 1 is an isometric view of the present utility model.

FIG. 2 is a front view of the present utility model.

FIG. 3 is a side view of the present utility model.

FIG. 4 is a top view of the present utility model.

FIG. 5 is a schematic view illustrating the present utility model when it is opened.

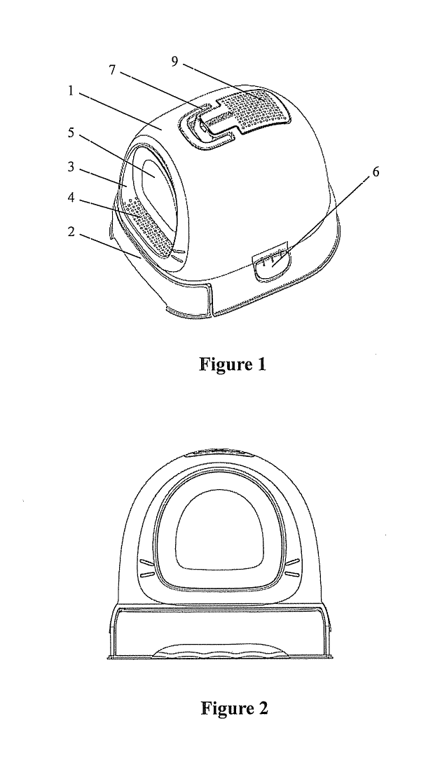

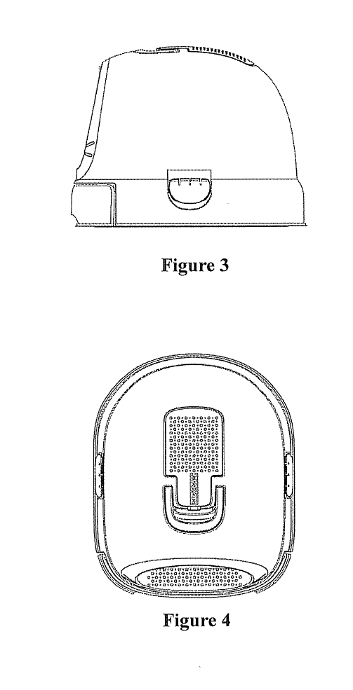

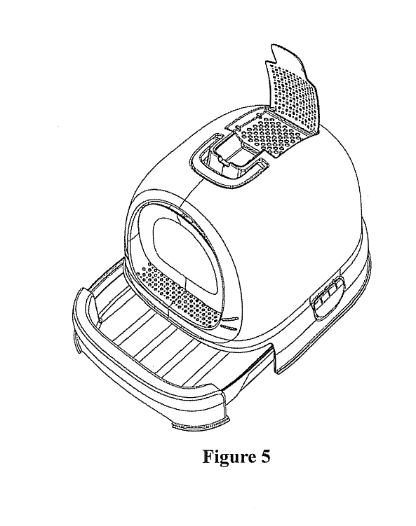

The numerals used in the drawings are illustrated as follows: 1 denotes cat lavatory body; 2 denotes cat litter pan; 3 denotes circular opening; 4 denotes cat litter footboard; 5 denotes revolving door; 6 denotes snap-fit connector; 7 denotes handle; 8 denotes retraction space; and 9 denotes lid.

### DETAILED DESCRIPTION

The present utility model provides an integrated fully enclosed cat lavatory comprising a cat lavatory body 1 and a cat litter pan 2, wherein: the cat lavatory body 1 is hexahedral and has an open underside, the cat litter pan 2 and the open underside of the cat lavatory body 1 are adaptable to each other. The top and two sides of the cat lavatory body 1 are curved, and preferably with a larger radius of curvature so that the surface looks similar to an inverted egg-shape structure and that the cat lavatory is overall pliable. The front of the cat lavatory body 1 is provided with a circular opening 3 for a cat to get in and out, and the circular opening 3 is horizontal near the bottom of the cat lavatory body 1. A cat litter footboard 4 extending from one side of the cat lavatory body 1 into the cat lavatory body 1 is formed at the bottom of the circular opening 3. The cat litter footboard 4 is provided with cat litter holes disposed thereon so that cat litter carried by cat claws is removed through the cat litter holes into the cat litter pan when the cat gets in and out of the cat lavatory to prevent cat litter from being taken out. A rectangular front inlet is disposed beneath the circular opening 3 to allow the cat litter pan 2 to be slid into the cat lavatory body 1 transversely.

The cat litter pan 2 of the present utility model can be slid into the cat lavatory body 1 to enclose the opening located at the bottom of the cat lavatory body 1. For cleaning of the cat litter pan 2, the cat litter pan 2 is withdrawn from the cat lavatory body 1 and after cleaning, the cat litter pan 2 is reinserted to the bottom of the cat lavatory body 1 to form a fully enclosed cat lavatory.

The fully enclosed cat lavatory of the present utility model is also provided with a revolving door 5 disposed at the circular opening 3 for enclosing the circular opening 3. The revolving door 5 is pivotally fixed to the circular opening 3. Typically, a revolving pivot is provided to the revolving door 5 at a location near the upper side of the circular opening 3, and a pin hole for accommodating the revolving pivot is disposed at the circular opening 3. When a pet cat gets in and out of the cat lavatory, the revolving door 5 is triggered to rotate around the revolving pivot thereon and opened. After the entry or exit of a pet cat, the circular opening 3 is enclosed by the revolving door 5 under the action of gravity.

The fully enclosed cat lavatory of the present utility model can also be provided with two snap-fit connectors 6 disposed on two sides of the cat lavatory body 1, and the height at which the snap-fit connectors 6 are disposed is adaptable to the height of the sides of the cat litter pan 2 at which the cat litter pan 2 is placed into the cat lavatory body 1 so that the snap-fit connectors 6 are engaged with two sides of the cat litter pan 2 to fix the cat litter pan 2 to the cat lavatory body 1 and to prevent the cat litter pan 2 the cat litter pan 2 from falling off accidentally during handling.

The fully enclosed cat lavatory of the present utility model is provided with a handle 7 disposed on the top thereof, the handle 7 is disposed at the central portion of the top of the cat lavatory and coincides with the center of the cat lavatory, and the handle 7 is pivoted to the cat lavatory body 1 in a retractable manner. The cat lavatory body 1 is provided with a retraction space 8 disposed near the handle 7, and the retraction space 8 can be an integral part of the cat lavatory body 1 and concaved from the top of the cat lavatory body 1 and formed integrally with the cat lavatory body. The retraction space 8 is provided with a lid 9 disposed thereon, the shape of the lid 9 and that of the retraction space 8 are adaptable to each other, and the lid 9 is pivoted to the cat lavatory body 1 to open and close the retraction space 8. The retraction space 8 can be used for storing cat litter shovel, cat comb and other tools. The bottom of the retraction space 8 and the lid 9 can also be provided with ventilation holes disposed thereon.

In one embodiment of the present invention, the cat lavatory body 1 is provided with slide ways disposed on two sides thereof near the bottom thereof, the slide ways can usually be formed by inwardly folding the bottom edges of the cat lavatory body 1 or having protruding ridges disposed on two sides near the bottom of the cat lavatory body 1, and the slide ways serve as pathways for the insertion of the cat litter pan 2 into the cat lavatory body 1 and the withdrawal thereof therefrom to guide the cat litter pan 2 to be conveniently and rapidly inserted into and withdrawn from the cat lavatory body 1.

In one embodiment of the present invention, the cat litter pan 2 is disposed like a drawer and a drawer pull is formed at the outer side of the cat litter pan 2 for convenient withdrawal thereof. The bottom of the cat litter pan 2 of the present utility model can be planar and is preferably provided with wavy structures for the effects of rib reinforcement to enhance its bearing capacity and to increase its durability. The wavy structures are disposed along the longitudinal direction in which the cat litter pan 2 is inserted into the cat lavatory body 1, and the bottom of the cat litter pan 2 is provided with rib reinforcement longitudinally disposed along the wavy protruding portions at the bottom of each wavy structure to reduce friction between the cat litter pan 2 and the floor when the cat litter pan 2 is pulled.

The fully enclosed cat lavatory of the present utility model is integrally formed and capable of creating a concealed and comfortable environment for pet cats, and its fully enclosed structure can prevent odor diffusion and cat litter spilling. The cat lavatory body and its sides are integrally designed such that the drawer-type cat litter pan is enwrapped by the sides of the cat lavatory body. For cleaning of the cat lavatory, the cat litter pan is withdrawn from the cat lavatory body and this makes cleaning convenient. Moreover, as the cat litter pan is inserted into the cat lavatory body like a drawer to form an integrated article, transportation of the cat lavatory and cleaning of the outside surface thereof are convenient, and the disposition of rib reinforcement at the bottoms of the wave structures reduces friction between the cat litter pan and the floor the cat litter pan is pulled.

Although the present utility model has been described with reference to several typical embodiments, it must be noted that the terms used are illustrative and exemplary rather than restrictive. As the present utility model can be implemented in various forms without departing from the spirit or substance, it must be understood that the foregoing embodiments are not limited to any of the aforementioned details, and must be construed broadly within its spirit and scope as set out in the accompanying claims, hence all changes and modifications falling within the claims or their equivalents shall be covered by the accompanying claims.

What is claimed is:

1. An integrated fully enclosed cat lavatory comprising a cat lavatory body and a cat litter pan, wherein: the cat lavatory body is hexahedral, the cat lavatory body has an open underside, the shape of the cat litter pan and that of the open underside of the cat lavatory body are adaptable to each other, the top and two sides of the cat lavatory body are curved, the front of the cat lavatory body is provided with a circular opening for a cat to get in and out, a cat litter footboard extending into the cat lavatory body is provided at the bottom of the circular opening, engagement slots are disposed beneath the circular opening for the cat litter pan to be engaged therewith, the cat litter pan is slid to be placed into the cat lavatory body to enclose the open underside of the cat lavatory body.

2. The integrated fully enclosed cat lavatory as defined in claim 1, characterized in that a revolving door is disposed at the circular opening for enclosing the circular opening.

3. The integrated fully enclosed cat lavatory as defined in claim 2, characterized in that the revolving door is pivotally fixed to the circular opening.

4. The integrated fully enclosed cat lavatory as defined in claim 1, characterized in that the cat lavatory body is provided with two snap-fit connectors disposed on two sides thereof, and the snap-fit connectors are engaged with two sides of the cat litter pan to fix the cat litter pan to the cat lavatory body.

5. The integrated fully enclosed cat lavatory as defined in claim 1, characterized in that the cat lavatory body is provided with a handle disposed on the top thereof, and the handle is disposed in a retractable manner.

6. The integrated fully enclosed cat lavatory as defined in claim 1, characterized in that the cat lavatory body is provided with a retraction space disposed on the top thereof, and the retraction space is concaved from the top of the cat lavatory body formed integrally with the cat lavatory body.

7. The integrated fully enclosed cat lavatory as defined in claim 6, characterized in that the retraction space is provided with a lid, and the shape of the lid and that of the retraction space are adaptable to each other.

8. The integrated fully enclosed cat lavatory as defined in claim 7, characterized in that the retraction space and the lid are provided with ventilation holes disposed thereon.

9. The integrated fully enclosed cat lavatory as defined in claim 1, characterized in that the cat lavatory body is provided with slide ways disposed on two sides thereof near the bottom thereof to guide the cat litter pan into the cat lavatory body when the cat litter pan is being placed into the cat lavatory body.

10. The integrated fully enclosed cat lavatory as defined in claim 1, characterized in that the cat litter pan is like a drawer, the bottom of the cat litter pan is provided with wavy structures, and each of the wavy structures is provided with rib reinforcement longitudinally disposed along the wavy structure at the bottom thereof.
